(19) United States
(12) Patent Application Publication
(10) Pub. No.: US 2022/0251415 A1
(43) Pub. Date: Aug. 11, 2022

(54) Polyimide Film-Forming Composition, Method of Preparing the Same, and Use Thereof

(71) Applicants: SK Innovation Co., Ltd., Seoul (KR); SK ie technology Co., Ltd., Seoul (KR)

(72) Inventors: Cheol Min Yun, Daejeon (KR); Hye Jin Park, Daejeon (KR); Hyun Joo Song, Daejeon (KR)

(21) Appl. No.: 17/591,738

(22) Filed: Feb. 3, 2022

(30) Foreign Application Priority Data
Feb. 5, 2021 (KR) 10-2021-0016993

(51) Int. Cl. C09D 179/08; C08J 5/18; C09D 7/20

(52) U.S. Cl. CPC C09D 179/08; C08J 2379/08; C09D 7/20; C08J 5/18

(57) ABSTRACT

The present disclosure relates to a polyimide film-forming composition, a method of preparing the same, and a use thereof. According to the present invention, there is provided a polyimide film that has excellent isotropic property and scattering resistance, is flexible, and has excellent bendability without deterioration of colorless and transparent optical properties. The polyimide film may be usefully used in various flexible display devices.

### CROSS-REFERENCE TO RELATED APPLICATION

This application claims priority to Korean Patent Application No. 10-2021-0016993 filed Feb. 5, 2021, the disclosure of which is hereby incorporated by reference in its entirety.

### BACKGROUND OF THE INVENTION

### Field of the Invention

The following disclosure relates to a polyimide film-forming composition, a method of preparing the same, and a use thereof.

### Description of Related Art

Display devices typified by thin type display devices such as a liquid crystal display device and an organic light emitting diode display device include various smart devices characterized by portability, ranging from a smart phone and a tablet PC to various wearable devices in recent years. Such smart devices have a cover window for a display device on a display panel in order to protect the display panel from scratches or external impacts. As such a cover window for a display device, tempered glass has been used in the related art, but in order to provide flexibility, a plastic film typified by a polyimide film and the like have been recently used instead of the tempered glass.

Recently, it is required for various smart devices to be flexible and even to have foldability, and requirements for more advanced flexibility have been increased.

Meanwhile, a polyimide film applied to the outermost window substrate of a smart device is required to have excellent optical properties such as a transmittance, a low refractive index, and a phase delay for securing a viewing angle of a display device. However, a color of common polyimide is brown or yellow. This is mainly due to a charge transfer complex (CTC) formed by intramolecular and intermolecular interactions of polyimide. The charge transfer complex causes a decrease in light transmittance of the polyimide film and an increase in birefringence, resulting in a narrow viewing angle. As a related prior art, KR 10-2015-0046463 A discloses a polyamic acid solution prepared using various dianhydrides and diamine compounds to implement colorless and transparent properties and improve birefringence and phase difference properties, and a method of producing a polyimide film using the same.

In addition, it is required for a plastic film such as a polyimide film to have improved mechanical properties in order to be applicable to a foldable or flexible display device. To this end, a method using a large amount of monomers having a rigid structure has been proposed. However, in this case, a yellow index is increased or adhesion to a substrate such as glass is reduced.

Therefore, there is still a demand for developing a material applicable to a cover window that may satisfy the performance requirement described above and may be used instead of expensive tempered glass.

### SUMMARY OF THE INVENTION

An embodiment is directed to providing a polyimide film-forming composition that may satisfy a performance required for an advanced cover window, a method of preparing the same, and a use thereof.

Another embodiment of the present invention is directed to providing a polyimide film that may simultaneously implement a low yellow index, a low haze, and room temperature stability, and a laminate including the same.

Still another embodiment is directed to providing a method of preparing a polyimide film-forming composition for implementing the physical properties described above, and a method of producing a polyimide film.

Still another embodiment is directed to providing a cover window used instead of tempered glass and the like, and a flexible display panel including the same.

In one general aspect, a polyimide film-forming composition contains: polyamic acid or polyimide including a unit derived from an aromatic diamine and a dianhydride; an amide-based solvent; and a hydrocarbon-based solvent, wherein the polyimide film-forming composition satisfies the following Relational Expression 1:

$$1 , 000 \leq {V}_{P I} \leq 3 , 500 \qquad [ Relational Expression 1 ]$$

wherein

V_{PI} is a viscosity of the polyimide film-forming composition when a solid content is 20 wt % with respect to a total weight of the polyimide film-forming composition, and the viscosity is a viscosity (unit: cp) measured at 25° C. with a Brookfield rotational viscometer using a 52Z spindle based on a torque of 80% and a time of 2 minutes.

In another general aspect, a method of preparing a polyimide film-forming composition includes: preparing polyamic acid by reacting an aromatic diamine with a dianhydride in an amide-based solvent; and additionally adding and allowing a hydrocarbon-based solvent to react so that Relational Expression 1 is satisfied.

In still another general aspect, a method of producing a polyimide film includes: applying the polyimide film-forming composition onto a substrate; and curing the polyimide film-forming composition by drying and heating the polyimide film-forming composition.

In still another general aspect, there is provided a polyimide film obtained by applying the polyimide film-forming composition onto a substrate and then curing the polyimide film-forming composition, and a laminate including the polyimide film.

In still another general aspect, there is provided a cover window for a display device including the polyimide film and a flexible display panel including the polyimide film.

As set forth above, according to the present disclosure, the intermolecular packing density during curing may be significantly reduced by inhibiting the interaction between the polyamic acid and the mixed solvent. Therefore, a polyimide film having excellent optical properties and improved adhesion without deterioration of colorless and transparent properties may be provided. In addition, the polyimide film is flexible and has excellent bendability, and may thus be applied to a cover window of a flexible display device.

According to the present disclosure, the intermolecular interaction, which is the disadvantage of the polyimide film, is efficiently controlled, such that the polyimide film may have excellent adhesion and may exhibit optical properties equivalent to those of the polyimide film according to the related art. Therefore, a mura phenomenon that causes a visibility problem when the polyimide film is used as a cover window of a display panel, in particular, a rainbow mura caused by a phase difference, is effectively suppressed. As a result, the reliability of the display panel including the polyimide film may be enhanced.

### BRIEF DESCRIPTION OF THE DRAWINGS

FIGS. 1 to 8 are photographs taken after polyimide films produced using polyimide film-forming compositions of Examples 1 to 6 and Comparative Examples 1 and 3 are left at room temperature.

### DESCRIPTION OF THE INVENTION

Hereinafter, a polyimide film-forming composition, a method of preparing the same, and a use thereof of the present invention will be described in detail. However, this is not intended to limit the protection scope limited by the claims.

In addition, unless otherwise defined, all the technical terms and scientific terms used in the description of the present invention have the same meanings as commonly understood by those skilled in the art to which the present invention pertains.

Throughout the specification describing the present invention, unless explicitly described to the contrary, “comprising” any components will be understood to imply further inclusion of other components rather than the exclusion of any other components.

Hereinafter, unless otherwise specifically defined in the present specification, it will be understood that when an element such as a layer, a film, a thin film, a region, or a plate, is referred to as being “above” or “on” another element, it may be “directly on” another element or may have an intervening element present therebetween.

Hereinafter, unless otherwise specifically defined in the present specification, a “combination thereof” refers to mixing or copolymerization of constituents.

Hereinafter, unless otherwise specifically defined in the present specification, “A and/or B” may refer to an aspect including both A and B, and may refer to an aspect selected from A and B.

Hereinafter, unless otherwise specifically defined in the present specification, “substituted” means that a hydrogen atom in a compound is substituted with a substituent. For example, the substituent may be selected from deuterium, a halogen atom (F, Br, Cl, or I), a hydroxy group, a nitro group, a cyano group, an amino group, an azido group, an amidino group, a hydrazino group, a hydrazono group, a carbonyl group, a carbamyl group, a thiol group, an ester group, a carboxyl group or a salt thereof, a sulfonic acid group or a salt thereof, a phosphoric acid or a salt thereof, a C1 to C30 alkyl group, a C2 to C30 alkenyl group, a C2 to C30 alkynyl group, a C6 to C30 aryl group, a C1 to C30 alkoxy group, a C3 to C30 heteroalkyl group, a C3 to C30 cycloalkyl group, a C3 to C30 heterocycloalkyl group, and a combination thereof. Here, the cycloalkyl group or the heterocycloalkyl group may be partially unsaturated.

Hereinafter, unless otherwise specifically defined in the present specification, a polymer includes an oligomer, a homopolymer, and a copolymer. The copolymer includes an alternating copolymer, a block copolymer, a random copolymer, a branched copolymer, a crosslinked copolymer, or all of them.

Hereinafter, unless otherwise specifically defined in the present specification, polyamic acid refers to a polymer having a structural unit having an amic acid moiety, and polyimide refers to a polymer having a structural unit having an imide moiety.

Hereinafter, unless otherwise specifically defined in the present specification, a “mura phenomenon” may be construed as including all distortions which may be caused by light at a specific angle. Examples of the mura phenomenon include distortions caused by light, such as a black out phenomenon in which a screen looks black, a hot spot phenomenon, and a rainbow phenomenon exhibiting iridescent stains, which occur in a display device including a polyimide film.

Hereinafter, a polyimide film-forming composition according to an exemplary embodiment will be described.

In the related art, there have been many attempts to combine or change monomers having various structures in order to improve optical properties and mechanical properties of a polyimide film while imparting functionality thereto. However, there is a trade-off relationship between the mechanical properties and the optical properties. Therefore, extremely general results in which the mechanical properties are improved, but the functionality is reduced or the optical properties are deteriorated are obtained through these attempts. Accordingly, there is a need for a new attempt to simultaneously provide excellent mechanical properties, functionality, and optical properties. The inventors of the present invention have found that these physical properties may be simultaneously improved by changing a solvent condition of a composition for forming a polyimide film (hereinafter, also referred to as a polyimide film-forming composition), and specifically, by applying a non-polar solvent that may not be used as a polymerization solvent of polyamic acid (hereinafter, also referred to as a polyimide precursor) and/or polyimide and has no affinity with polyimide.

The optical properties, the functionality, and the mechanical properties of the polyimide film may be simultaneously improved by applying the non-polar solvent, and in particular, it is possible to provide a polyimide film that has adhesiveness equal to or higher than that of the existing optical adhesive film, has an improved yellow index, and implements a significant reduction in distortion caused by light. Accordingly, a polyimide film produced using the polyimide film-forming composition according to an exemplary embodiment may be applied to a new substrate material or a cover window material that may be applied to a foldable or flexible display device. Since the polyimide film has excellent visibility, the user's eye fatigue may be minimized.

A polyimide film-forming composition according to an exemplary embodiment may contain polyamic acid and/or polyimide, a polar solvent, and a non-polar solvent. The polar solvent may be a hydrophilic solvent, may have affinity with, for example, polyamic acid and/or polyimide, and may be, for example, an amide-based solvent. In addition, the non-polar solvent may have almost no affinity with polyamic acid and/or polyimide, and may be, for example, a hydrocarbon-based solvent.

While not wishing to be bound by a certain theory, when a mixed solvent of an amide-based solvent and a hydrocarbon-based solvent is used, an intermolecular interaction between polymers and/or an interaction between a polymer and a solvent may be effectively inhibited, and an intermolecular packing density during curing may be significantly reduced, such that desired excellent optical properties and mechanical properties may be simultaneously improved.

Therefore, in the polyimide film-forming composition according to an exemplary embodiment, intermolecular behavior and interaction may be simply different from those in a mixed solution in a polymerization process of polyamic acid. For example, in a case where the hydrocarbon-based solvent is contained in the polymerization process of polyamic acid, the hydrocarbon-based solvent may act as a factor inhibiting polymerization. Therefore, a high molecular weight polyamic acid may not be obtained. On the other hand, in the polyimide film-forming composition according to an exemplary embodiment, after obtaining polyamic acid and/or polyimide having a sufficiently high molecular weight, the hydrocarbon-based solvent is mixed, such that the hydrocarbon-based solvent may act as a catalyst to weaken an intermolecular interaction between polymers and/or a strong interaction between a polymer and a solvent, and desired optical properties may be obtained in subsequent curing.

Specifically, the polyimide film-forming composition according to an exemplary embodiment may contain: polyamic acid or polyimide including a unit derived from an aromatic diamine and a dianhydride; an amide-based solvent; and a hydrocarbon-based solvent, and may satisfy the following Relational Expression 1. While not wishing to be bound by a certain theory, the polyimide film-forming composition satisfying these conditions may inhibit a packing density of a coating layer, that is, a polyimide film, and may render the film amorphous, resulting in improvement of the optical properties.

$$1 , 000 \leq {V}_{P I} \leq 3 , 500 \qquad [ Relational Expression 1 ]$$

wherein

V_{PI} is a viscosity of the polyimide film-forming composition when a solid content is 20 wt % with respect to a total weight of the polyimide film-forming composition, and the viscosity is a viscosity (unit: cp) measured at 25° C. with a Brookfield rotational viscometer using a 52Z spindle based on a torque of 80% and a time of 2 minutes. Here, the solids may be the polyamic acid and/or the polyimide.

Therefore, it is possible to provide a polyimide film satisfying optical properties in which a yellow index is 2.5 or less and a haze is 0.1 or less. In addition, according to an exemplary embodiment, the effect is remarkable in terms of obtaining improved scattering resistance because an improved yellow index is implemented and adhesion to a substrate such as glass is excellent. Furthermore, the polyimide film may have improved adhesion and excellent mechanical properties.

More specifically, a hydrocarbon-based solvent may be mixed with a polyamic acid solution containing: polyamic acid including a unit derived from an aromatic diamine and a dianhydride; and an amide-based solvent so as to satisfy Relational Expression 1. Here, the amide-based solvent and the hydrocarbon-based solvent are sequentially used, such that an interaction between the polyamic acid that is a polyimide precursor and the solvent may be controlled in a more appropriate range. Here, the control may refer to inhibition.

The amide-based solvent refers to a compound having an amide moiety. The amide-based solvent may be an aromatic or aliphatic solvent, and may be, for example, an aliphatic solvent. In addition, the amide-based solvent may be, for example, a cyclic compound or a chain compound. Specifically, the amide-based solvent may have 2 to 15 carbon atoms, and may have, for example, 3 to 10 carbon atoms.

The amide-based solvent may have an N,N-dialkylamide moiety. Dialkyl groups may be each independently present or may be fused with each other to form a ring, or at least one alkyl group in the dialkyl group may be fused with another substituent in the molecule to form a ring. For example, at least one alkyl group in the dialkyl group may be fused with an alkyl group linked to a carbonyl carbon of the amide moiety to form a ring. Here, the ring may be a 4- to 7-membered ring, and may be, for example, a 5- to 7-membered ring, or a 5- or 6-membered ring. The alkyl group may be, for example, a C1 to C10 alkyl group or a C1 to C8 alkyl group, and may be, for example, methyl, ethyl, or the like.

More specifically, the amide-based solvent is not limited as long as it is generally used in polymerization of polyamic acid, and examples thereof include dimethylpropionamide, diethylpropionamide, dimethylacetylamide, diethylacetamide, dimethylformamide, methylpyrrolidone, ethylpyrrolidone, octylpyrrolidone, and a combination thereof. Specifically, the amide-based solvent may contain dimethylpropionamide.

The hydrocarbon-based solvent may be a non-polar molecule as described above.

The hydrocarbon-based solvent may be a compound composed of carbon and hydrogen. The hydrocarbon-based solvent may be, for example, an aromatic or aliphatic solvent. The hydrocarbon-based solvent may be, for example, a cyclic compound or a chain compound, and specifically may be a cyclic compound. Here, in a case where the hydrocarbon-based solvent is a cyclic compound, the hydrocarbon-based solvent may contain a single ring or a polycyclic ring, and the polycyclic ring may be a condensed ring or a non-condensed ring, and specifically may be a single ring.

The hydrocarbon-based solvent may have, for example, 3 to 15 carbon atoms, 6 to 15 carbon atoms, or 6 to 12 carbon atoms.

The hydrocarbon-based solvent may be a substituted or unsubstituted C3 to C15 cycloalkane, a substituted or unsubstituted C6 to C15 aromatic compound, or a combination thereof. Here, the cycloalkane may be cyclobutane, cyclopentane, cyclohexane, cycloheptane, cyclooctane, or a combination thereof, and the aromatic compound may be benzene, naphthalene, or a combination thereof.

The hydrocarbon-based solvent may be a cycloalkane substituted or unsubstituted with at least one C1 to C5 alkyl group, an aromatic compound substituted or unsubstituted with at least one C1 to C5 alkyl group, or a combination thereof. Here, each of the cycloalkane and the aromatic compound is as described above.

The C1 to C5 alkyl group may be, for example, a C1 to C3 alkyl group or a C1 or C2 alkyl group, and more specifically may be a methyl group, but is not limited thereto.

In addition, the hydrocarbon-based solvent may further contain oxygen, if necessary. For example, in a case where the hydrocarbon-based solvent contains oxygen, the hydrocarbon-based solvent may contain a ketone group or a hydroxy group, and the hydrocarbon-based solvent may be cyclopentanone, cresol, or a combination thereof.

Specifically, the hydrocarbon-based solvent may be benzene, toluene, cyclohexane, cyclopentanone, cresol, or a combination thereof, but is not limited thereto.

More specifically, the polyimide film-forming composition according to an exemplary embodiment may contain a mixed solvent including an amide-based solvent containing dimethylpropionamide and a hydrocarbon-based solvent selected from toluene, benzene, and cyclohexane.

In the polyimide film-forming composition according to an exemplary embodiment, the aromatic diamine may be used without limitation as long as it is commonly used in the art. Non-limiting examples thereof include one or two or more selected from p-phenylenediamine (p-PDA), m-phenylenediamine (m-PDA), 4,4′-oxydianiline (4,4′-ODA), 3,4′-oxydianiline (3,4′-ODA), 2,2-bis[4-(4-aminophenoxy)phenyl]propane (BAPP), 1,4-bis(4-aminophenoxy)benzene (TPE-Q), 1,3-bis(4-aminophenoxy)benzene (TPE-R), 4,4′-bis(4-aminophenoxy)biphenyl (BAPB), 2,2-bis[4-(4-aminophenoxy)phenyl]sulfone (BAPS), 2,2-bis[4-(3-aminophenoxy)phenyl]sulfone (m-BAPS), 3,3′-dihydroxy-4,4′-diaminobiphenyl (HAB), 3,3′-dimethylbenzidine (TB), 2,2′-dimethylbenzidine (m-TB), 2,2′-bis(trifluoromethyl)benzidine (TFMB), 1,4-bis(4-amino-2-trifluoromethylphenoxy)benzene (6FAPB), 2,2′-bis(trifluoromethyl)-4,4′-diaminodiphenyl ether (6FODA), 1,3-bis(3-aminophenoxy)benzene (APB), 1,4-naphthalenediamine (1,4-ND), 1,5-naphthalenediamine (1,5-ND), 4,4′-diaminobenzanilide (DABA), 6-amino-2-(4-aminophenyl)benzoxazole, and 5-amino-2-(4-aminophenyl)benzoxazole.

In addition, the aromatic diamine may include a fluorine-based aromatic diamine in terms of providing a film having a high total light transmittance and a low haze. Here, specific examples of the fluorine-based aromatic diamine include 2,2′-bis(trifluoromethyl)benzidine (TFMB), 1,4-bis(4-amino-2-trifluoromethylphenoxy)benzene (6FAPB), and 2,2′-bis(trifluoromethyl)-4,4′-diaminodiphenyl ether (6FODA). These fluorine-based aromatic diamines may be used alone or mixed with another known aromatic diamine.

In the polyimide film-forming composition according to an exemplary embodiment, the dianhydride may be used without limitation as long as it is commonly used in the art. Non-limiting examples thereof include one or two or more selected from pyromellitic dianhydride (PMDA), 3,3′,4,4′-biphenyltetracarboxylic dianhydride (BPDA), 3,3′,4,4′-benzophenonetetracarboxylic dianhydride (BTDA), 4,4′-oxydiphthalic anhydride (ODPA), 4,4′-(4,4′-isopropylbiphenoxy)biphthalic anhydride (BPADA), 3,3′,4,4′-diphenylsulfonetetracarboxylic dianhydride (DSDA), 2,2-bis-(3,4-dicarboxyphenyl)hexafluoropropane dianhydride (6FDA), p-phenylene bistrimellitic monoester anhydride (TMHQ), 2,2-bis(4-hydroxyphenyl)propanedibenzoate-3,3′,4,4′-tetracarboxylic dianhydride (ESDA), naphthalenetetracarboxylic dianhydride (NTDA), and ethylene glycol bis(anhydrotrimellitate) (TMEG).

In addition, the dianhydride according to an exemplary embodiment may include ethylene glycol bis(anhydrotrimellitate) (TMEG), and in this case, excellent mechanical properties may be implemented without introducing monomers having a rigid structure for increasing mechanical strength of the film. In addition, the interaction between the polyamic acid prepared using the above dianhydride and the solvent may be effectively inhibited, and thus, the intermolecular packing density during curing may be significantly reduced, which may be significantly advantageous in providing desired optical properties. In addition, the dianhydride may be used by being mixed with one or two or more selected from pyromellitic dianhydride (PMDA), 3,3′,4,4′-biphenyltetracarboxylic dianhydride (BPDA), 3,3′,4,4′-benzophenonetetracarboxylic dianhydride (BTDA), 4,4′-oxydiphthalic anhydride (ODPA), 4,4′-(4,4′-isopropylbiphenoxy)biphthalic anhydride (BPADA), 3,3′,4,4′-diphenylsulfonetetracarboxylic dianhydride (DSDA), 2,2-bis-(3,4-dicarboxyphenyl)hexafluoropropane dianhydride (6FDA), p-phenylene bistrimellitic monoester anhydride (TMHQ), 2,2-bis(4-hydroxyphenyl)propanedibenzoate-3,3′,4,4′-tetracarboxylic dianhydride (ESDA), and naphthalenetetracarboxylic dianhydride (NTDA), but is not limited thereto.

In addition, in the polyimide film-forming composition according to an exemplary embodiment, the dianhydride may further include a monomer having a rigid structure such as 9,9-bis(3,4-dicarboxyphenyl)fluorene dianhydride (BPAF).

In addition, in the polyimide film-forming composition according to an exemplary embodiment, the dianhydride may further include a cycloaliphatic dianhydride, if necessary.

The polyimide film-forming composition according to an exemplary embodiment contains the polyamic acid and/or polyimide including a unit derived from an aromatic diamine and a dianhydride exemplified above.

A weight average molecular weight (Mw) of the polyamic acid and/or the polyimide may be 10,000 to 80,000 g/mol, 10,000 to 70,000 g/mol, or 10,000 to 60,000 g/mol.

In a case where the polyamic acid and/or the polyimide is dissolved in a common amide-based solvent alone, a viscosity of the solution may be 4,000 cp or more, 5,000 cp or more, or 7,000 cp or less. Here, the viscosity of the solution refers to a viscosity when a solid content is 20 wt % with respect to the total weight of the solution. Here, the solids may be the polyamic acid and/or the polyimide.

Meanwhile, even when the polyimide film-forming composition according to an exemplary embodiment contains a high solid content of 20 wt %, the viscosity of the composition may be significantly reduced, and thus, the composition may be applied to a thin film coating process with a high solid content and a low viscosity. In general, it is required for the composition to have a high solid content of 15 wt % or more (with respect to the total weight of the composition) in order to be used for thin film coating, and in the case of polyimide, the viscosity tends to be increased as a concentration of the solids is increased. In this case, when a flow of the polymer is not smooth, bubbles are generated and a mura occurs in coating. However, when an exemplary embodiment is applied, these defects in the thin film coating process may be effectively prevented, such that further improved optical properties may be implemented. In addition, in the case where the polyamic acid and/or the polyimide is dissolved in an amide-based solvent alone as described above, it is difficult to increase the concentration of the solids due to a high viscosity, resulting in a reduction in process efficiency. However, according to an exemplary embodiment, a polyimide film-forming composition having a high solid content may be used without causing such a problem, which is commercially advantageous.

The solid content in the polyimide film-forming composition may be 40 wt % or less, 35 wt % or less, or 10 to 30 wt %, with respect to the total weight of the polyimide film-forming composition.

The viscosity (V_{PI}) of the polyimide film-forming composition according to an exemplary embodiment may be 3,000 cp or less, 2,500 cp or less, or 1,000 to 2,000 cp.

The polyimide film-forming composition according to an exemplary embodiment may contain 5 to 60 wt % of the hydrocarbon-based solvent. Here, wt % is based on the total weight of the solvent, and the total weight of the solvent as a reference refers to the sum of the total weights of the amide-based solvent and the hydrocarbon-based solvent.

In addition, in order to implement further improved yellow index and haze, the hydrocarbon-based solvent may be contained in an amount of 15 wt % or more or 25 wt % or more. In addition, when the hydrocarbon-based solvent is contained in an amount of 25 to 60 wt %, adhesion to a substrate such as glass may be significantly improved together with the above effect.

In addition, in an exemplary embodiment, a molded article produced using the polyimide film-forming composition described above is provided.

A first aspect of the molded article according to an exemplary embodiment may be a polyimide film.

Further, a second aspect of the molded article according to an exemplary embodiment may be a laminate including the polyimide film.

Further, a third aspect of the molded article according to an exemplary embodiment may be a cover window for a display device including the polyimide film.

Further, a fourth aspect of the molded article according to an exemplary embodiment may be a flexible display panel including the polyimide film.

The polyimide film according to an exemplary embodiment may have a yellow index (YI) of 2.5 or less, 2.0 or less, or 1.85 or less, when measured according to ASTM E313.

In addition, the polyimide film according to an exemplary embodiment may satisfy the yellow index described above and may have a haze of 0.1 or less, 0.08 or less, more than 0 and less than 0.05, when measured according to ASTM D1003.

In addition, the polyimide film according to an exemplary embodiment satisfies excellent optical properties such as the yellow index and the haze described above, and implements a significant reduction in distortion caused by light.

The polyimide film according to an exemplary embodiment for satisfying all of the physical properties described above may be exemplified as follows, but is not limited thereto.

The polyimide film according to an exemplary embodiment may include the unit derived from the aromatic diamine and the dianhydride, and the aromatic diamine and the dianhydride may be mixed and polymerized in a molar ratio of 1:0.9 to 1:1.1. In this case, the hydrocarbon-based solvent added after preparing a polyamic acid solution according to an exemplary embodiment provides an advantage in improving optical properties of the polyimide film. In addition, the viscosity of the composition is significantly reduced to provide an advantage in process.

The hydrocarbon-based solvent may be selected from, for example, toluene, benzene, and cyclohexane.

The polyimide film according to an exemplary embodiment may include a unit derived from a fluorine-based aromatic diamine such as 2,2′-bis(trifluoromethyl)benzidine (TFMB) and ethylene glycol bis(anhydrotrimellitate) (TMEG), and may be applied onto a substrate such as glass and then thermally cured. In addition, various known methods such as a chemical curing method, an infrared curing method, a batch curing method, and a continuous curing method may be used, or a different curing method may be applied.

An application method for forming the polyimide film may be used without limitation as long as it is commonly used in the art. Non-limiting examples thereof include a knife coating method, a dip coating method, a roll coating method, a slot die coating method, a lip die coating method, a slide coating method, and a curtain coating method, and the same or different methods may be sequentially applied one or more times.

In addition, adhesion of the polyimide film according to an exemplary embodiment to a substrate such as glass may be 5 gf/in or more, 10 gf/in or more, or 15 gf/in or more.

Since the polyimide film according to an exemplary embodiment has a reduced intermolecular density, the polyimide film is more preferably applied to a cover window of a flexible display or the like, because it does not cause distortion in a screen. In addition, according to an exemplary embodiment, as described above, it is found that this phenomenon is prevented even when 9,9-bis(3,4-dicarboxyphenyl)fluorene dianhydride (BPAF) having a bulky structure with rigid structural characteristics is not used, and a transparent polyimide film having remarkable desired optical properties may be provided.

A weight average molecular weight of the polyimide constituting the polyimide film according to an exemplary embodiment is not particularly limited, and may be 10,000 g/mol or more, 20,000 g/mol or more, or 25,000 to 80,000 g/mol. In addition, a glass transition temperature thereof is not limited, and may be 100 to 400° C., and more specifically 100 to 380° C.

In addition, the laminate according to an exemplary embodiment may include the polyimide film according to an exemplary embodiment formed on a substrate. Here, at least two or more coating layers, that is, polyimide films obtained using a polyimide film-forming composition containing monomers having different compositions may be formed in the laminate.

The laminate may further include a functional coating layer formed on at least one other surface of the polyimide film or the substrate, if necessary. Non-limiting examples of the functional coating layer include a hard coating layer, an antistatic layer, an anti-fingerprint layer, an anti-fouling layer, an anti-scratch layer, a low-refractive layer, an anti-reflective layer, and an impact absorption layer, and one or two or more functional coating layers may be provided.

In order to prevent scattering, the molded article may include a polyimide film according to an exemplary embodiment formed on one surface of a substrate, and a hard coating layer formed on at least one other surface of the substrate.

In addition, specific examples of the molded article produced using the polyimide film-forming composition according to an exemplary embodiment include a cover window for a display device, a print wiring board including a protective layer or an insulating layer, and a flexible printed circuit board, and are not limited thereto. In addition, the molded article may be applied to a protective film that may replace tempered glass, and may be widely used in various industrial fields including a display device because it has improved optical properties.

Specifically, the molded article may be used as a cover window of a flexible display panel or the like because it has excellent optical properties such as a low haze and a low yellow index. A cover window including the polyimide film according to an exemplary embodiment may have excellent optical properties and exhibits a sufficient phase difference at various angles, such that a wide viewing angle may be secured.

In addition, specific examples of the molded article produced using the polyimide film-forming composition according to an exemplary embodiment include a flexible display panel or flexible display device including the cover window described above, but are not limited thereto. In this case, the cover window may be used as the outermost window substrate of the flexible display device. The flexible display device may be various image display devices such as a general liquid crystal display device, an electro-luminescence display device, a plasma display device, and a field emission display device.

A thickness of the polyimide film according to an exemplary embodiment may be 1 to 500 μm, 10 to 250 μm, or 10 to 100 μm.

In addition, the polyimide film according to an exemplary embodiment may further include one or two or more functional coating layers selected from a hard coating layer, an antistatic layer, an anti-fingerprint layer, an anti-fouling layer, an anti-scratch layer, a low-refractive layer, an anti-reflective layer, and an impact absorption layer depending on the purpose. In this case, a thickness of the functional coating layer may be 1 to 500 μm, 2 to 450 μm, or 2 to 200 μm.

A display device including the cover window according to an exemplary embodiment described above has excellent display quality and scattering resistance and implements a significant reduction in distortion caused by light, resulting in excellent visibility. Therefore, the user's eye fatigue may be minimized. In particular, in accordance with an increase in size of a screen of a display device, the screen has been often viewed from the side. In a case where the polyimide film according to an exemplary embodiment is applied to the display device, the display device has excellent visibility even when viewed from the side. Therefore, the polyimide film may be usefully applied to a large display device.

In addition, the polyimide film-forming composition according to an exemplary embodiment may be prepared by a preparation method, the preparation method including: preparing polyamic acid by reacting an aromatic diamine with a dianhydride in an amide-based solvent; and additionally adding and allowing a hydrocarbon-based solvent to react so that Relational Expression 1 is satisfied.

In addition, according to an exemplary embodiment, a method of producing the polyimide film may be provided.

In an exemplary embodiment, the production method is not limited as long as a film that may satisfy physical properties in which a yellow index (YI) is 2.5 or less and a haze is 0.1 or less is produced. A method to be described below is merely specifically described as an example, and the production method is not limited to a method to be described below as long as a film satisfying the physical properties described above is produced.

Specifically, a method of producing a polyimide film according to an exemplary embodiment may include: applying a polyimide film-forming composition onto a substrate such as glass; and thermally curing or drying and thermally curing the polyimide film-forming composition. More specifically, the method of producing a polyimide film according to an exemplary embodiment may include: preparing a polyimide film-forming composition by preparing a polyamic acid solution including a unit derived from an aromatic diamine and a dianhydride in an amide-based solvent and then additionally adding a hydrocarbon-based solvent to satisfy Relational Expression 1; applying the polyimide film-forming composition onto a substrate such as glass; and curing the polyimide film-forming composition.

The curing may be performed by drying and thermal curing.

The drying may be performed at 30 to 70° C., 35 to 65° C., or 40 to 55° C.

The thermal curing may be performed at 80 to 300° C., 100 to 280° C., or 150 to 250° C.

The thermal curing may be performed at 80 to 100° C. for 1 minute to 2 hours, at higher than 100 to 200° C. for 1 minute to 2 hours, or at higher than 200 to 300° C. for 1 minute to 2 hours, and stepwise thermal curing may be performed under two or more temperature conditions selected therefrom. In addition, the thermal curing may be performed in a separate vacuum oven, an oven filled with an inert gas, or the like, but is not limited thereto.

The curing may be performed by chemical curing.

The chemical curing may be performed using an imidization catalyst. As a non-limiting example of the imidization catalyst, one or two or more selected from pyridine, isoquinoline, and β-quinoline may be used, but it is not limited thereto.

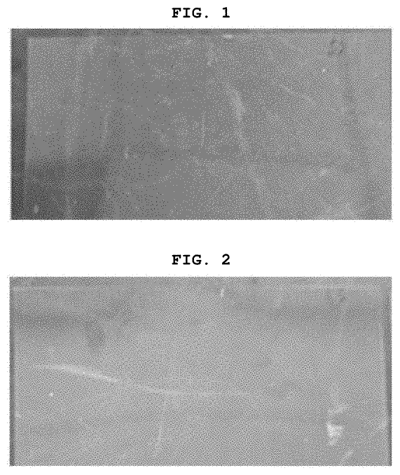

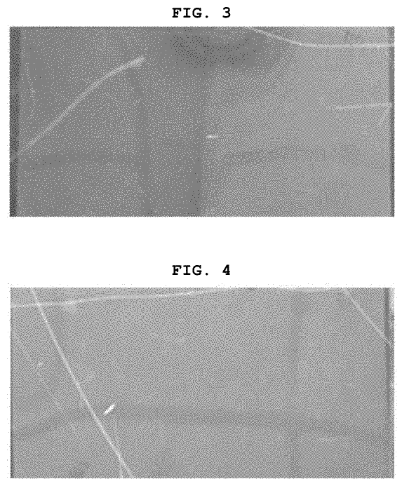

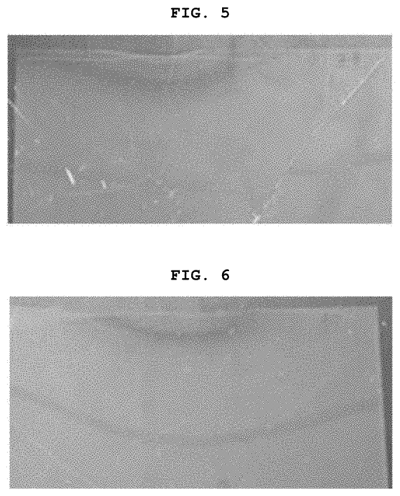

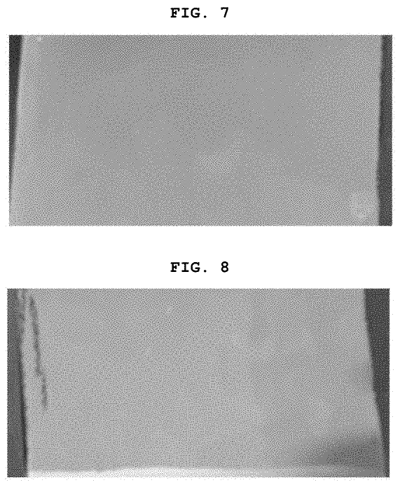

The method of producing a polyimide film according to an exemplary embodiment may further include, after the applying of the polyimide film-forming composition onto the substrate, leaving the polyimide film-forming composition at room temperature, if necessary. Optical properties of a surface of the film may be further stably maintained by the leaving of the polyimide film-forming composition. While not wishing to be bound by a certain theory, when a polyimide film-forming composition according to the related art is left before being cured, a solvent absorbs moisture in the air, the moisture diffuses inside, and the moisture collides with polyamic acid and/or polyimide, which causes whitening from a surface of a film and lumping, and as a result, coating unevenness may occur (see FIGS. 7 and 8). On the other hand, the polyimide film-forming composition according to an exemplary embodiment does not cause whitening and lumping even when left in the air for a long time, and may realize the advantage of being able to secure a film having improved optical properties (see FIGS. 1 to 6).

The leaving of the polyimide film-forming composition may be performed under room temperature and/or high humidity conditions. Here, the room temperature may be 40° C. or lower, 30° C. or lower, or 25° C. or lower, and more specifically may be 15 to 25° C. or 20 to 25° C. In addition, the high humidity may be a relative humidity of 50% or more, 60% or more, 70% or more, or 80% or more.

The leaving of the polyimide film-forming composition may be performed for 1 minute to 3 hours, 10 minutes to 2 hours, or 20 minutes to 1 hour.

In addition, in the method of producing a polyimide film according to an exemplary embodiment, a polyimide film may be produced by mixing the polyamic acid solution with one or two or more additives selected from a retardant, an adhesion enhancer, an inorganic particle, an antioxidant, an ultraviolet inhibitor, or a plasticizer.

The substrate may be used without limitation as long as it is commonly used in the art, and as a non-limiting example thereof, glass; stainless steel; or a plastic film formed of polyethylene terephthalate, polyethylene naphthalate, polypropylene, polyethylene, cellulose triacetate, cellulose diacetate, poly(meth)acrylic acid alkyl ester, a poly(meth)acrylic acid ester copolymer, polyvinyl chloride, polyvinyl alcohol, polycarbonate, polystyrene, cellophane, a polyvinylidene chloride copolymer, polyamide, polyimide, a vinyl chloride-vinyl acetate copolymer, polytetrafluoroethylene, or polytrifluoroethylene may be used, but it is not limited thereto.

Hereinafter, the present invention will be described in more detail with reference to Examples, but the present invention is not limited to the following Examples.

In the following Examples, physical properties were measured as follows.

<Viscosity (V_{PI})>

In order to measure a viscosity, 0.5 ul of a polyimide film-forming composition (a concentration of solids of 20 wt %) was put in a container, a spindle was lowered, an rpm was adjusted, it waited for 2 minutes when a torque reached 80%, and a viscosity value when there was no change in torque was measured with a plate rheometer (trade name: LVDV-III Ultra, manufactured by Brookfield Engineering Labs., Inc.). At this time, the viscosity was measured under a temperature condition of 25° C. using a 52Z spindle. A unit of the viscosity is cp.

<Yellow Index (YI)>

A yellow index was measured in accordance with the ASTM E313 standard using a spectrophotometer (COH-5500, manufactured by Nippon Denshoku Industries Co., Ltd.).

<Haze>

A haze was measured in accordance with the ASTM D1003 standard using a spectrophotometer (COH-5500, manufactured by Nippon Denshoku Industries Co., Ltd.). A unit of the haze is %.

<Weight Average Molecular Weight>

A weight average molecular weight was measured by dissolving a film in a DMAc eluent containing 0.05 M LiCl. Waters GPC System, Waters 1515 Isocratic HPLC Pump, Waters 2414 Refractive Index Detector were used for GPC, Olexis, Polypore, and Mixed D Column were connected to each other and used as a column, polymethyl methacrylate (PMMA STD) was used as a standard material, and the analysis was performed at 35° C. and a flow rate of 1 mL/min.

### Example 1

### Preparation of Polyimide Film-Forming Composition

133.5 g of N,N-dimethylpropionamide (DMPA) was filled in a stirrer with flowing nitrogen gas, and then, 39 g of 2,2′-bis(trifluoromethyl)benzidine (TFMB) was dissolved in a state where a temperature of a reactor was maintained at 25° C. 50 g of ethylene glycol bis(anhydrotrimellitate) (TMEG100) was added thereto at a temperature of 50° C. and stirring was performed under dissolution. After stirring for 6 hours, 133.5 g of toluene was added at 25° C., and stirring was performed for 18 hours. Thereafter, DMPA and/or toluene was added so that a solid content was 20 wt % and a content of toluene in the composition was 50 wt % with respect to the total weight of DMPA and toluene (that is, DMPA:Toluene=50 wt %/50 wt %). The viscosity of the prepared polyimide film-forming composition is shown in Table 2.

### Examples 2 to 7

### Preparation of Polyimide Film-Forming Compositions

Polyimide film-forming compositions were prepared in the same manner as that of Example 1, except that DMPA and/or toluene was added so that the content of toluene with respect to the total weight of DMPA and toluene satisfied the T Content shown in Table 1. The viscosity of the prepared polyimide film-forming composition is shown in Table 2.

### Example 8

### Preparation of Polyimide Film-Forming Composition

82.7 g of N,N-dimethylpropionamide (DMPA) was filled in a stirrer with flowing nitrogen gas, and then, 21.3 g of 2,2′-bis(trifluoromethyl)benzidine (TFMB) was dissolved in a state where a temperature of a reactor was maintained at 25° C. 20 g of 3,3′,4,4′-biphenyltetracarboxylic dianhydride (BPDA) was added thereto at a temperature of 50° C. and stirring was performed under dissolution. After stirring for 6 hours, 87 g of toluene was added at 25° C., and stirring was performed for 18 hours. Thereafter, DMPA and/or toluene was added so that a solid content was 20 wt % and a content of toluene in the composition satisfied the T Content shown in Table 1.

### Example 9

### Preparation of Polyimide Film-Forming Composition

80.9 g of N,N-dimethylpropionamide (DMPA) was filled in a stirrer with flowing nitrogen gas, and then, 20.43 g of 2,2′-bis(trifluoromethyl)benzidine (TFMB) was dissolved in a state where a temperature of a reactor was maintained at 25° C. 20 g of 4,4′-oxydiphthalic anhydride (ODPA) was added thereto at a temperature of 50° C. and stirring was performed under dissolution. After stirring for 6 hours, 80.9 g of toluene was added at 25° C., and stirring was performed for 18 hours. Thereafter, DMPA and/or toluene was added so that a solid content was 20 wt % and a content of toluene in the composition satisfied the T Content shown in Table 1.

### Example 10

### Preparation of Polyimide Film-Forming Composition

64.3 g of N,N-dimethylpropionamide (DMPA) was filled in a stirrer with flowing nitrogen gas, and then, 12.15 g of 2,2′-bis(trifluoromethyl)benzidine (TFMB) was dissolved in a state where a temperature of a reactor was maintained at 25° C. 20 g of 4,4′-(4,4′-isopropylbiphenoxy)biphthalic anhydride (BPADA) was added thereto at a temperature of 50° C. and stirring was performed under dissolution. After stirring for 6 hours, 64.3 g of toluene was added at 25° C., and stirring was performed for 18 hours. Thereafter, DMPA and/or toluene was added so that a solid content was 20 wt % and a content of toluene in the composition satisfied the T Content shown in Table 1.

### Example 11

### Preparation of Polyimide Film-Forming Composition

143 g of N,N-dimethylpropionamide (DMPA) was filled in a stirrer with flowing nitrogen gas, and then, 36.5 g of 1,4-bis(4-amino-2-trifluoromethylphenoxy)benzene (6FAPB) was dissolved in a state where a temperature of a reactor was maintained at 25° C. 20 g of TMEG100 was added thereto at a temperature of 50° C. and stirring was performed under dissolution. After stirring for 6 hours, 143 g of toluene was added at 25° C., and stirring was performed for 18 hours. Thereafter, DMPA and/or toluene was added so that a solid content was 20 wt % and a content of toluene in the composition satisfied the T Content shown in Table 1.

### Example 12

### Preparation of Polyimide Film-Forming Composition

76.5 g of N,N-dimethylpropionamide (DMPA) was filled in a stirrer with flowing nitrogen gas, and then, 41 g of 2,2′-bis(trifluoromethyl)-4,4′-diaminodiphenyl ether (6FODA) was dissolved in a state where a temperature of a reactor was maintained at 25° C. 20 g of TMEG100 was added thereto at a temperature of 50° C. and stirring was performed under dissolution. After stirring for 6 hours, 76.5 g of toluene was added at 25° C., and stirring was performed for 18 hours. Thereafter, DMPA and/or toluene was added so that a solid content was 20 wt % and a content of toluene in the composition satisfied the T Content shown in Table 1.

### Comparative Example 1

267 g of N,N-dimethylpropionamide (DMPA) was filled in a stirrer with flowing nitrogen gas, and then, 39 g of 2,2′-bis(trifluoromethyl)benzidine (TFMB) was dissolved in a state where a temperature of a reactor was maintained at 25° C. 50 g of ethylene glycol bis(anhydrotrimellitate) (TMEG100) was added thereto at a temperature of 50° C. and stirring was performed under dissolution for 6 hours. Thereafter, DMPA was added so that a solid content was 20 wt %. The viscosity of the prepared polyimide film-forming composition is shown in Table 2.

### Comparative Example 2

A polyimide film-forming composition was prepared in the same manner as that of Example 1, except that DMPA and/or toluene was added so that the content of toluene with respect to the total weight of DMPA and toluene satisfied the T Content shown in Table 1. The viscosity of the prepared polyimide film-forming composition is shown in Table 2.

### Comparative Example 3

294.3 g of N,N-dimethylpropionamide (DMPA) was filled in a stirrer with flowing nitrogen gas, and then, 31.2 g of 2,2′-bis(trifluoromethyl)benzidine (TFMB) was dissolved in a state where a temperature of a reactor was maintained at 25° C. 20 g of ethylene glycol bis(anhydrotrimellitate) (TMEG100) and 22.35 g of 9,9-bis(3,4-dicarboxyphenyl)fluorene dianhydride (BPAF) were added to the TFMB solution at a temperature of 50° C., and stirring was performed under dissolution for 6 hours. Thereafter, DMPA was added so that a solid content was 20 wt %.

### Comparative Example 4

A polyimide film-forming composition was prepared in the same manner as that of Comparative Example 1, except that DEF was used instead of DMPA, and DEF(N,N-diethylformamide) and/or toluene was added so that the content of toluene with respect to the total weight of DEF and toluene satisfied the T Content shown in Table 1 in Comparative Example 1. It was confirmed that the viscosity of the prepared polyimide film-forming composition was 4,000 cp.

TABLE 1

| | T Content (wt %) |
|---|---|
| Example 1 | 50 |
| Example 2 | 60 |
| Example 3 | 40 |
| Example 4 | 30 |
| Example 5 | 25 |
| Example 6 | 5 |
| Example 7 | 15 |
| Example 8 | 50 |
| Example 9 | 50 |
| Example 10 | 50 |
| Example 11 | 50 |
| Example 12 | 50 |
| Comparative Example 1 | 0 |
| Comparative Example 2 | 65 |
| Comparative Example 3 | 0 |
| Comparative Example 4 | 20 |

<Evaluation of Formability and Optical Properties of Film>

Each of the polyimide film-forming compositions of Examples 1 to 12 and Comparative Examples 1 to 4 was applied onto one surface of a glass substrate (1.0 T) with a #20 meyer bar, and the polyimide film-forming composition was dried under a nitrogen atmosphere at 50° C. for 1 minute. Thereafter, the dried polyimide film-forming composition was heated at 230° C. for 10 minutes to form a coating layer, and physical properties of the coating layer were measured. The results are shown in Table 2.

TABLE 2

| | Comparative | | | | | | Comparative |
|---|---|---|---|---|---|---|---|
| | Example 1 | Example 1 | Example 2 | Example 3 | Example 4 | Example 5 | Example 2 |
| Viscosity | 3,500 | 1,200 | 1,100 | 1,300 | 1,200 | 1,400 | 500,000 or more |
| T Content | 0 | 50 | 60 | 40 | 30 | 25 | 65 |
| Thickness | 12.3 | 12.3 | 12.3 | 12.3 | 12.3 | 12.3 | — |
| YI | 2.58 | 1.82 | 1.78 | 1.73 | 1.79 | 1.99 | Polymerization |
| Haze | 0.05 | 0.03 | 0.04 | 0.03 | 0.01 | 0.02 | impossible |

Referring to Tables 1 and 2, it could be confirmed that in the case of the polyimide film-forming composition according to an exemplary embodiment, since the viscosity was 1,000 to 3,500 cp and the mixed solvent of the amide-based solvent and the hydrocarbon-based solvent was contained, a film having a sufficient thickness to be used as a cover film of a flexible display device was formed.

On the other hand, in the case of the polyimide film-forming composition prepared in Comparative Example 2, the viscosity of the solution was increased to an uncontrollable level due to a high solid content in the initial polymerization, and thus, the polymerization was impossible. In addition, in the case of the polyimide film-forming composition prepared in Comparative Example 4, the viscosity was high compared to the solid content and the bubbles were not removed, and thus, there was a disadvantage in process and the coating surface was not uniform. Therefore, the surface of the coating layer after curing was slightly rough and was evaluated as “poor”, and it could be confirmed that the polyimide film-forming composition was unsuitable for production of a polyimide film. Further, it was confirmed that in the case of the polyimide film-forming composition of Comparative Example 4, the surface after coating was rough, and thus, the optical properties were significantly deteriorated.

On the other hand, it could be confirmed that in the case of the polyimide film produced using the polyimide film-forming composition according to an exemplary embodiment, a yellow index was significantly improved and excellent optical properties were implemented. In addition, the polyimide film according to an exemplary embodiment does not cause distortion of a screen, is flexible, and has excellent bendability, and may thus be usefully applied as a cover window of a flexible display device.

In addition, it can be confirmed that the polyimide film according to an exemplary embodiment has excellent scattering resistance because it has excellent adhesion.

On the other hand, in the case of the polyimide film-forming composition prepared in Comparative Example 1, the intermolecular packing density during thermal curing is increased, and thus the values of the yellow index and the haze of the polyimide film produced using the same are large. However, it can be confirmed that the values of the yellow index and the haze of the film of each of Examples are small, which shows that the film has excellent transparency compared with the film of Comparative Example 1.

<Evaluation of Room Temperature Stability>

Each of the polyimide film-forming compositions of Examples 1 to 12 and Comparative Examples 1 to 4 was applied onto one surface of a glass substrate (1.0 T) with a #20 meyer bar, and the polyimide film-forming composition was dried at 50° C. for 1 minute. Thereafter, the polyimide film was left at a temperature of 40° C. and a humidity of 80% for 30 minutes, and then, a photograph of the polyimide film was taken.

FIGS. 1 to 8 are photographs taken of the films left after being produced using the polyimide film-forming compositions of Examples 1 to and Comparative Examples 1 and 3 under the above conditions, respectively.

Referring to FIGS. 1 to 8, it could be confirmed that in the polyimide films produced using the polyimide film-forming compositions of Examples 1 to 6, whitening and lumping did not occur, but in the polyimide films produced using the polyimide film-forming compositions of Comparative Examples 1 and 3, whitening or lumping occurred from the surfaces. It was confirmed from these results that in the films produced using the polyimide film-forming compositions according to Examples, the room temperature stability was excellent even under the high humidity condition compared with the films of Comparative Examples, and thus, excellent coatability, optical properties, and productivity were secured.

Hereinabove, although the present disclosure has been described by limited exemplary embodiments in the present specification, the exemplary embodiments have been provided only for assisting in the entire understanding of the present invention. Therefore, the present invention is not limited to the exemplary embodiments. Various modifications and changes may be made by those skilled in the art to which the present invention pertains from this description.

Therefore, the spirit of the present invention should not be limited to the described exemplary embodiments, but the claims and all modifications equal or equivalent to the claims are intended to fall within the scope and spirit of the present invention.

What is claimed is:

1. A polyimide film-forming composition comprising:
polyamic acid or polyimide comprising a unit derived from an aromatic diamine and a dianhydride;
an amide-based solvent; and
a hydrocarbon-based solvent,
wherein the polyimide film-forming composition satisfies the following Relational Expression 1:
$$1 , 000 \leq {V}_{P I} \leq 3 , 500 \qquad [ Relational Expression 1 ]$$
wherein
V_{PI} is a viscosity of the polyimide film-forming composition when a solid content is 20 wt % with respect to a total weight of the polyimide film-forming composition, and the viscosity is a viscosity (unit: cp) measured at 25° C. with a Brookfield rotational viscometer using a 52Z spindle based on a torque of 80% and a time of 2 minutes.

2. The polyimide film-forming composition of claim 1, wherein the amide-based solvent contains dimethylpropionamide.

3. The polyimide film-forming composition of claim 1, wherein the hydrocarbon-based solvent is a cyclic hydrocarbon-based solvent.

4. The polyimide film-forming composition of claim 3, wherein the hydrocarbon-based solvent is toluene, benzene, cyclohexane, or a combination thereof.

5. The polyimide film-forming composition of claim 1, wherein the hydrocarbon-based solvent is contained in an amount of 5 to 60 wt % with respect to a total weight of the amide-based solvent and the hydrocarbon-based solvent.

6. The polyimide film-forming composition of claim 1, wherein the hydrocarbon-based solvent is contained in an amount of 25 to 60 wt % with respect to a total weight of the amide-based solvent and the hydrocarbon-based solvent.

7. The polyimide film-forming composition of claim 1, wherein a solid content in the polyimide film-forming composition is 10 to 40 wt % with respect to the total weight of the polyimide film-forming composition.

8. A method of preparing a polyimide film-forming composition, comprising:
preparing polyamic acid by reacting an aromatic diamine with a dianhydride in an amide-based solvent; and
additionally adding and allowing a hydrocarbon-based solvent to react so that the following Relational Expression 1 is satisfied:
$$1 , 000 \leq {V}_{P I} \leq 3 , 500 \qquad [ Relational Expression 1 ]$$
wherein
V_{PI} is a viscosity of the polyimide film-forming composition when a solid content is 20 wt % with respect to a total weight of the polyimide film-forming composition, and the viscosity is a viscosity (unit: cp) measured at 25° C. with a Brookfield rotational viscometer using a 52Z spindle based on a torque of 80% and a time of 2 minutes.

9. A method of producing a polyimide film, comprising:
applying the polyimide film-forming composition of claim 1 onto a substrate; and
curing the polyimide film-forming composition by drying and heating the polyimide film-forming composition.

10. The method of claim 9, wherein the curing of the polyimide film-forming composition is performed by drying the polyimide film-forming composition at 30 to 70° C. and then heating the polyimide film-forming composition at 80 to 300° C.

11. The method of claim 9, further comprising, after the applying of the polyimide film-forming composition, leaving the polyimide film-forming composition at room temperature.

12. A polyimide film obtained by applying the polyimide film-forming composition of claim 1 onto a substrate and then curing the polyimide film-forming composition.

13. The polyimide film of claim 12, wherein the polyimide film has a yellow index (YI) of 2.5 or less when measured according to ASTM E313.

14. The polyimide film of claim 13, wherein the polyimide film has a haze of 0.1 or less when measured according to ASTM D1003.

15. The polyimide film of claim 12, wherein the polyimide film has a thickness of 1 to 500 μm.

16. A laminate comprising the polyimide film of claim 12 formed on one surface of the substrate.

17. The laminate of claim 16, further comprising one or more coating layers selected from a hard coating layer, an antistatic layer, an anti-fingerprint layer, an anti-fouling layer, an anti-scratch layer, a low-refractive layer, an anti-reflective layer, and an impact absorption layer, the coating layer being formed on at least one other surface of the substrate.

18. A cover window for a display device comprising the polyimide film of claim 12.

19. A flexible display panel comprising the polyimide film of claim 12.
